(19) United States
(12) Patent Application Publication
(10) Pub. No.: US 2010/0261397 A1
(43) Pub. Date: Oct. 14, 2010

(54) NONWOVEN FLAME RESISTANT MATERIALS AND PROCESS FOR MAKING THE SAME

(75) Inventors: Michel Sabourin, Blanville (CA); Alvin Zoltan, Montreal-Nord (CA)

Correspondence Address: KNOBBE MARTENS OLSON & BEAR LLP, 2040 MAIN STREET, FOURTEENTH FLOOR, IRVINE, CA, 92614, US

(73) Assignee: Jaztex Fibers, Inc., Pointe Claire (CA)

(21) Appl. No.: 12/757,481

(22) Filed: Apr. 9, 2010

Related U.S. Application Data
(60) Provisional application No. 61/168,045, filed on Apr. 9, 2009.

(51) Int. Cl. B32B 5/02; D04H 3/14; B05D 1/02

(52) U.S. Cl. 442/136; 156/148; 427/427.7

(57) ABSTRACT

Disclosed is a process for making fire resistant materials, such as fabrics or barriers, comprising the steps of selecting cellulosic fibers and optionally synthetic fibers; feeding a machinery serving to make the nonwoven material with the fibers, and treating the fibers at least one time with at least one fire retardant chemical compound while the machinery is making the non-woven material for obtaining the requested fire resistant nonwoven material. Preferably, an aqueous solution containing the fire retardant chemical compounds is spread on the nonwoven web before, during and/or after the web is heated up during a thermo bonding step of the process. The process is environmentally friendly and allows for higher impregnation of the fibers with fire retardant chemicals.

### CROSS-REFERENCE TO RELATED APPLICATIONS

This application claims the benefit of U.S. Provisional Application No. 61/168,045, filed Apr. 9, 2009.

### BACKGROUND OF THE INVENTION

1. Field of the Invention

The present invention relates to nonwoven flame or fire resistant materials such as fabrics and/or barriers, used in the making of goods such as, but not limited to furniture, mattresses, insulating materials for vehicle seats, protective garments, clothing, uniforms or the like; that need to be flame or fire resistant and comply with national or international regulations. The present invention also relates to a new process for making such fire resistant fabrics or barriers.

2. Description of the Related Art

Historically, it has been an objective of the industry to produce flame retardant fabrics for a variety of end uses, including apparel, furniture, upholstery construction, transport, insulation, and uniform fabrics. To date, these efforts have been largely focused on cellulosic fabrics, which are readily made flame retardant by the addition of phosphorous-based flame retardant chemicals (U.S. Pat. No. 3,253,881 (DONAHUE); or U.S. Pat. Nos. 3,827,907 and 3,970,425 (LEBLANC et al.)).

The conventional process known in the art to produce a nonwoven FR (“FR” for “flame resistant” or “fire resistant”) barrier or fabric in the industry, is a two step process comprising:
purchasing either an FR inherent or FR pre-treated fibers; and
processing the FR inherent or FR per-treated fibers into a nonwoven finish product that meet the customer's requirements.

By FR inherent fiber, it is to be understood that the fiber is made inherently flame resistant through the incorporation of a FR solution or any other require additives, in the process of manufacturing the fiber itself. As an example, a FR solution may be introduced into FR viscose before processing the fiber.

By FR treated fiber, it is to be understood that the fiber is made first from a non-treated material, and then it is treated using a FR solution in a wet process. As an example, the company Tintoria Piana US, Inc. (USA, Georgia) uses a close loop wet system to transform regular untreated FR (or raw fibers) fibers into FR fibers (see U.S. Pat. No. 7,201,287 B2 cited below).

There are two distinct construction processes in the nonwoven process. The first one is named Dry-laid and involves carding, garnetting or aerodynamic web forming or centrifugal web random card. The second one is a wet-laid process.

Regarding the general making of a nonwoven fabric, fibers are generally carded to straighten out the fibers. Layers of carded fibers are cumulated or stacked in either the machine direction or in cross machine direction. The fabric is then consolidated by thermal bonding, needle punching, chemical bonding, stitch bonding, hydro entanglement or any combination thereof.

Thermal bonding may be accomplished by adding low melt fibers and/or powders that have a lower melting point than the other fibers and by heating the fabric such that the low melt fibers melt. These fibers and or powder act as an adhesive in a web because their softening point is less than the softening point of the other fibers in the material.

Needle punching involves mechanically interlocking the fibers into a web to physically entangle the fiber layers. Typically, the more the fabric is needled, the lower the loft and the higher the strength. The loft of the nonwoven can be set by the amount of needle punching applied, the frequency of the penetration and/or the number of barbs on each needle.

With thermally bonded material, loft can be controlled by compressing the fabric in the oven and blowing air through the fabric as the fabric is cooled.

Chemical bonding may be accomplished by incorporating a liquid binder (e.g. latex) onto one or both sides of the carded fabric and drying and curing the fabric in an oven.

The nonwoven fabric are then cut and rolled for sale to manufacturers for incorporation into various types of products such as mattresses, furniture, etc.

Therefore, the process for making a nonwoven fabric generally uses a Garnett™ machine (or opener of the fiber bales), a carding machine, an Air-Laid™ machine, a thermo-bonding oven, a needle-punching machine, etc.

All the current manufacturers are buying, either treated fibers (ex: from Tintoria Piana US, Inc.) or inherent FR fibers from outside suppliers such as from Korea, Japan, China, Taiwan or other countries, then transporting these FR fibers overseas to their respective factories, and then start the nonwoven forming process from these inherent or FR treated fibers.

The treatment of the raw fibers for rendering them fire resistant is very water/energy consuming and its transportation from overseas is also energy consuming, which is undesirable for obvious reasons.

The making of fire retardant fabrics or barriers has been the subject matter of several patents and/or patent applications in the past.

GB 2 245 606 A (OWEN et al.) relates to an interliner for interposing between an outer fabric and resilient wadding, using nonwoven fibrous web comprising Teklan™ (modified acrylic), wool, chlorofibers such as vinyl chloride, aramide, polyamide, such as nylon®, polyimide, cross-linked acrylate, polybenzimidazole, FR Viscose, oxidized acrylic, or a mixture of some or all such fibers. In each case the fibers are of the type which when subjected to flame, tend to char rather than burn. OWEN et al. do not described the use of fire retardant chemicals.

U.S. Pat. No. 7,259,117 B2 (MATER et al.) describes a nonwoven high loft flame barrier which uses a blend of inherently flame retardant fibers and modacrylic fibers, i.e. fibers extruded from polymers made from halogenated monomers. However, the making of inherently retardant fibers is water and energy consuming and amodacrylic fibers are expensive, making it difficult to provide high quality, low cost products to consumers.

U.S. Pat. No. 7,326,664 (HARTGROVE et al.) relates to a flame retardant bedding article which comprises a hydro-entangled flame retardant nonwoven component, and more specifically, a bedding article such as a mattress, pillow cover or mattress pad, comprising a structurally stable, flame retardant, nonwoven component. The component comprises at least two layers that have a synergistic relationship so as to maintain the structural integrity of the bedding article upon burning.

U.S. Pat. No. 7,201,287 B2 (PIANA et al.) relates to closed-loop system and process used for applying fire retardant chemicals to fibers. Fibers are preferably positioned in a vessel such as a dye machine which circulates the fire retardant chemicals. After absorption of the fire retardant composition, non-absorbed fire retardant chemicals are recovered and re-used on subsequent batches of fibers. Recovery can be achieved by directing the non-absorbed fire retardant composition into a second dye machine containing additional fibers, or by extracting the fire retardant composition by centrifugation or other means, or by a combination of the two processes. This process by PIANA et al. concerns thus the treatment of fibers before the making of the fabric or barrier.

U.S. 2007/0186353 A1 (FANG) relates to a process of treating fibers to be fire resistant with water durability, with an aqueous solution comprising a phosphoric or phosphonic acid salt and a weak base. The fibers are dried at 140 to 200° C. The process by FANG uses pretreated FR fibers for the making of a textile.

U.S. 2008/038973 A1 (SASSER et al.) relates to a woven fabric coated on one side with an elastomeric composition into which a flame retardant compound has been incorporated. The fabric is then cured to fix the flame retardant into the fabric. This patent application does not relate to the treatment of nonwoven fabric for the purpose of making a nonwoven flame barrier.

U.S. Pat. No. 7,410,920 B2 and continuation U.S. 2009/0053494 A1 (DAVIS), relate to a lightweight fire retardant barrier made of inherent FR fibers for use in products such as mattresses and furniture. The fire retardant barrier can comprise charring modified viscose fibers having a denier of about 3.5 or less.

The principal drawbacks of the FR barriers or fabrics of the art reside in that:
they are made by using inherent or pre-treated fibers, the making of such fibers requiring a large amount of water and energy; and
they may comprise a mix of FR treated cellulosic fibers with non-treated synthetic fibers, leading to lower fire resistance properties compared to full-treated fabrics.

The principal drawbacks in the nonwoven processes of the prior art using inherent and/or FR treated fibers are that:
they present difficulties to be processed; and
they cause fibers breakages causing dust, as these FR fibers are more brittle and they are matted, clumped and/or fused.

All these drawbacks cause a lost of the fiber integrity.

Therefore, there is a need for a new process to come up with a new nonwoven FR barrier or fabric that meets the industry standard requirements, the process being otherwise less energy and water consuming and leading to a fire retardant barrier or fabric.

### SUMMARY OF THE INVENTION

The object of the invention is a process for making a fire resistant nonwoven material, which comprises the steps of:
a. selecting cellulosic fibers and optionally synthetic fibers;
b. feeding a machinery serving to make the nonwoven material with said fibers, and
c. treating said fibers at least one time with at least one fire retardant chemical compound while said machinery is making the non-woven material for obtaining the requested fire resistant nonwoven material.

Preferably, in step a, use is made of both cellulosic fibers and synthetic fibers; and step b comprises the sub-steps of:
b1. intermingling the fibers selected in step a) to form a structured nonwoven web; and
b2. heating the structured nonwoven web of step b1) for thermally bonding the synthetic fibers to the cellulosic fibers and forming a consolidated nonwoven web.

More preferably, in step c, the nonwoven web is treated before, during and/or after sub-step b2) with a given amount of at least one fire retardant chemical compound.

Another object of the invention is a fire retardant nonwoven material obtained by the above process.

Another object of the invention is an article comprising a fire retardant non-woven material obtained by the above process, the article being furniture, a mattress, an insulating material, a protective garment, clothing, a uniform, or the like. The insulating material may be used in construction or for insulating vehicle seats or the like.

Yet another object of the invention is the use of a least one fire retardant nonwoven material as defined above for the making of an article being a furniture, a mattress, an insulating material, a protective garment, clothing, an uniform, or the like. The insulating material may be used in construction or for insulating vehicle seats or the like.

One of the advantages of the present invention compared to the process of the prior art resides in that it is the nonwoven material that is fire retardant treated and not the fibers themselves, leading to a higher content of treated fibers within the material and consequently to enhanced properties, such as better fire or flame protection and resistance, and characteristics improvements, such as color and softness.

The barrier may also be made with fire retardant pre-treated or inherent material. In that case, the process of the invention allows to improve or increase the pre-existing fire retardant properties of the fibers.

The process also presents flexibility to fire retardant (FR) treat and form in a nonwoven FR material, with a large selection of mix natural and/or synthetic fibers.

The process of the present invention also allows to mix untreated and FR treated, synthetic and/or natural fibers and/or animal fibers, to provide other nonwoven FR barrier alternatives solutions, to the industry with the use of larger quantity of local and/or regional raw materials.

Preferably, a majority of fibers, if not all fibers, present in the nonwoven web of the invention are FR treated, compared to the conventional process known in the art that only uses inherent and/or pre-treated FR fibers mixed with non-treated fibers such as low melt or bi-components, which count for about 20 to about 25% by weight of the non-treated fibers.

The process of the invention is a continuous and integrated FR treatment and nonwoven forming process line that comprises one or more steps of FR treatment for all fibers while forming the nonwoven FR barrier.

Examples of characteristics improvements and advantages of the nonwoven FR material produced by the process of the present invention are:
reducing considerably the production process cost, making the nonwoven FR material very competitive on the market industry;
reducing the amount of CO₂ emission in the environment by using less transport;
using less energy in the application of the FR chemical compound and the drying of the FR material, and
reducing the amount of water compared to the amount of water generally used for the making of inherent or FR retardant fibers.

The application of the FR treatment in the new nonwoven process of the invention has a significant positive improvement on maintaining the fibers integrity, compared to the existing FR process. The present process does not generate a large amount of dust from the FR fibers, as per the conventional process. The present process provides a better working environment with considerably less dust in the air.

The color of the finish nonwoven FR barrier will be more white and homogeneous with the present process, than conventional process.

The present process is more environmentally friendly than conventional process, because it is not a full wet process and do not leave any FR chemicals outside of the process.

The present process is easy and cost effective to duplicate multiple production lines in several areas, in order to reduce shipping cost and increase customer's service.

The objects, advantages and other features of the present invention will be better understood upon reading of the following non-restrictive description of preferred embodiments thereof, given for the purpose of exemplification only, made with reference to the following drawing and example.

### BRIEF DESCRIPTION OF THE DRAWINGS

FIG. 1 is a diagram illustrating a multi-step process for the making of a nonwoven fire retardant material in accordance with a first preferred embodiment of the invention.

FIG. 2 is a diagram illustrating a multi-step process for the making of a nonwoven fire retardant material in accordance with a second preferred embodiment of the invention.

FIG. 3 is a diagram illustrating a multi-step process for the making of a nonwoven fire retardant material in accordance with a third preferred embodiment of the invention.

### DETAILED DESCRIPTION OF PREFERRED EMBODIMENTS

In the present application, the abbreviation “FR” is used for “Fire Retardant”, “Fire Resistant” and/or any other suitable equivalent.

In the present application, the expression term “material” encompasses the terms “fabric”, “web”, “barrier” or the like. The material can be a lofty, felt and/or board material as those well known and used in the art of mattresses, upholstered furniture and other end user applications where a FR nonwoven material is desired for flame barrier purposes.

In the present application, by “about”, it has to be understood that the measures indicated in the present application have a precision which cannot be inferior to the precision of the apparatus used to get this measure. It is commonly accepted that a 10% precision measure is acceptable and encompasses the term “about”.

As used herein wt. % means weight % unless otherwise indicated. When used herein % refers to weight % as compared to the total weight percent of the composition or the material that is being discussed. For example, when 1 wt. % is used to discuss the amount of a FR chemical compound in an aqueous solution, this means 1 g of said compound for 100 g of water.

The invention concerns a process for making of fire resistant nonwoven material made of fibers by treating the fibers with an effective amount of at least one fire retardant chemical while making the nonwoven material.

More particularly, the invention as claimed concerns a process for making a fire resistant nonwoven material, which comprises the steps of:
a. selecting cellulosic fibers and optionally synthetic fibers;
b. feeding a machinery serving to make the nonwoven material with the fibers, and
c. treating said fibers at least one time with at least one fire retardant chemical compound while said machinery is making the non-woven material for obtaining the requested fire resistant nonwoven material.

Preferably, the process of the invention is a continuous and integrated FR treatment combined with a nonwoven forming process system.

Preferably, the nonwoven fabric comprises FR treated fibers, inherent fibers and/or non FR treated fibers. Preferably, the fibers comprise natural, vegetal, synthetic fibers or a mix thereof. More preferably, the fibers are cellulosic fibers, synthetic fibers or a mix thereof.

The FR material may be a high loft or felt flame barrier comprising a blend of fibers that are treated for being fire resistant and essentially none shrinking to direct flame, which are thermally activated in a high loft manufacturing process to provide low bulk density, resiliency and insulation properties in the end use application.

The “machinery” used in the process is an assembly of machines and tools well known in the art for the making of nonwoven fabrics and barriers, such as those that will described in detail herein below.

The invention also relates to at least one FR nonwoven material comprising cellulosic fibers intermingled or not with synthetic fibers and a given amount of at least one fire retardant chemical compound.

Preferably, the FR nonwoven material comprises:
from about 75 wt. % to about 100 wt. % of cellulosic fibers;
from about 0 to about 25 wt. % of synthetic fibers;
and a given amount of at least one fire resistant chemical compound.

More preferably, the weight percent of cellulosic fibers is from about 75 wt. % to about 95 wt. %, and much more preferably it is about 80 wt. %; and the weight percentage of the synthetic fibers is from about 5 wt. % to about 25 wt. %, and much more 20 wt. %.

The FR nonwoven material may a batt, a web, a felt, a board or the like, and has a weight of at least about 50 grams per square meter (gsm), preferably between about 50 gsm to about 5000 gsm, and more preferably between 150 and 350 gsm. The fabric could be also in multiple layers or a mix of layers.

The present invention further concerns the use of the above-mentioned fire retardant material for the making of article such as, but not limited to, furniture, mattresses, insulating materials, vehicle seats, protective garments, clothing, construction, transport, uniforms or the like. These articles need to be fire resistant. For example, they may comply with national or international regulations, such as the US consumer product safety commission (CPSC) 16 CFR 1632 and/or 1633 (open flame), or any other norms or regulation from other industries.

The present invention also relates to furniture, mattresses, insulating materials for building or vehicle construction, FR vehicle seats, FR protective garments, or FR clothing comprising the above-mentioned FR material in order to comply with national or international regulations, such as CPSC: 16 CFR 1632 and/or 1633.

The preferred FR barriers or fabrics are designed to withstand extended periods of time exposed to open flame with minimal shrinkage of the char barrier, thereby preventing a flames from “breaking through” the char barrier or fabric and igniting underlying materials.

The high loft flame barrier of this invention also allows the manufacture of open flame resistant composite articles, while also permitting the continued use of conventional non-flame retardant dress cover fabrics, conventional non-flame retardant fiber fills and conventional non-flame retardant polyurethane foams.

### The Fibers

The fibers used for the making of the FR barrier of the invention may be made from raw or virgin fibers comprising a blend of synthetic and/or cellulosic fibers. Virgin fibers are fibers that are not inherent of FR pre-treated fibers.

In the present application, the term “cellulosic” preferably refers to fibers, yarns, and fabrics made of, or derived from, cellulose. The most common example is cotton. However, it is to be understood that fabrics made from other cellulosic materials, such as viscose or rayon (regenerated cellulose), acetate (cellulose acetate), triacetate (cellulose triacetate), jute, hemp or the like, may be used according to the present invention, as can be easily understood by a person skilled in the art.

In the present application, the term “synthetic” preferably refers to fibers, yarns, and fabrics that are chemically produced, such as polymers synthesized from chemical compounds. Examples include, without limitation, polyamides (nylon®), polyester, polyethylene, polypropylene, polyvinyl, and acrylic.

The synthetic fibers may also comprise thermo-binding fibers such as mono or bi-component fibers. Bi-component fibers include a first component, the sheath, having a first relatively lower “softening point” and a second component, the core, having a second relatively higher “softening point”. For example, they may have a polyester core with a “softening point” of about 220-240° C. surrounded by a low “softening point” polyester sheath having a “softening point” of about 110° C. These polymers are also named Low-Melt polyesters (LM polyester). Mono-component fibers are made of a polymer with a softening point of about 90° C. or about 110° C.

During the making of the nonwoven fire resistant material, a given amount of a thermo bonding powdered resin may be added to the fibers. This powdered resin can be used in combination with thermo bonding fibers or when the FR material does not comprise thermo-bonding fibers. Thermo bonding powdered resins may be any resins used in the art such as those commercialized by RAMCON-FIBERLOK, INC. (USA) under the name FLEX-TEL™.

The weight percent of cellulosic fibers may be from about 70 wt. % to about 100 wt. %, preferably from about 75 wt. % to about 95 wt. %, and more preferably it is about 80 wt. %. Respectively, the weight percentage of the synthetic fibers may be from 0 to about 30 wt. %, preferably from about 5 wt. % to about 25 wt. %, and more preferably of about 20 wt. %.

### The Nonwoven Processes:

### Process 1:

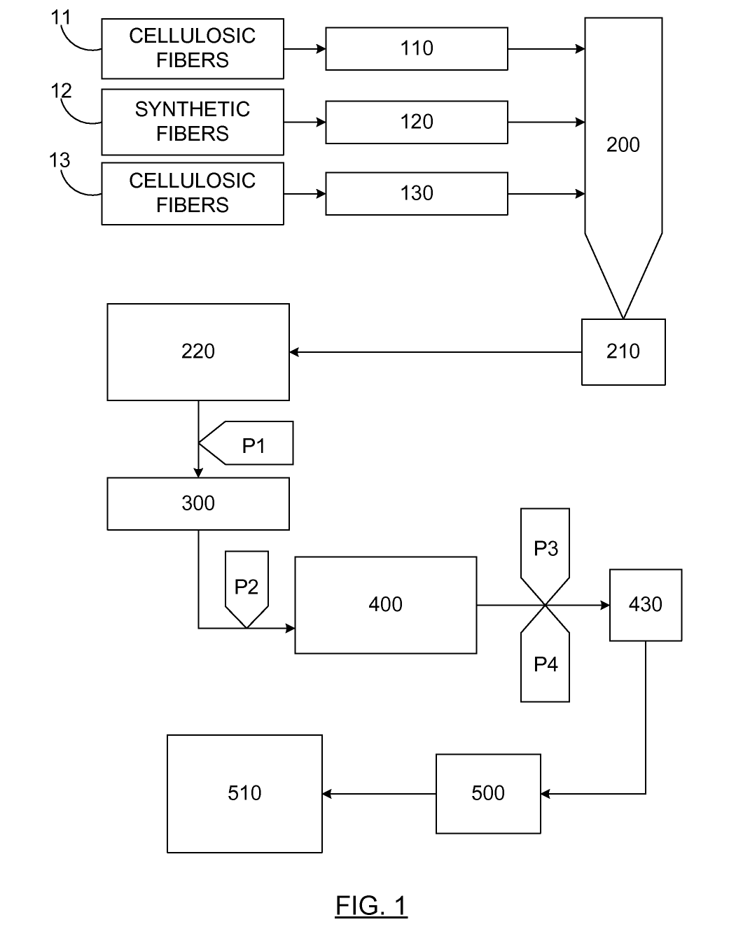

A process for the making of an FR nonwoven material according to a first preferred embodiment of the invention, is illustrated on FIG. 1. Process 1 includes at least the following steps.

### Step 1:

Three bale openers 110, 120 and 130 are fed respectively with:
a first bale of non treated cellulosic fibers (11);
a bale of non treated synthetic fibers (12); and
a second bale of non treated cellulosic fibers (13).

The distribution of one bale of non-treated cellulosic fibers into two equivalent bales of non-treated cellulosic fibers may allow a better mixing of the cellulosic and synthetic fibers. Preferably, the proportion of cellulosic fibers/synthetic fibers/cellulosic fibers is 40/20/40%.

For example, the first and second bales of cellulosic fibers (11,13) may comprise viscose and the bale of synthetic fibers (12) may comprise LM polyester.

Bale openers (110,120,130) are those well-known in the art such as a piece of equipment to open fibers from the bale. The bales are unstrapped and placed side-by-side in line with the milling head of a bale opener. The fibers are picked up from the top of the bales by two opening rolls in conjunction with a partial air vacuum. The opening head traverses back and forth across the bale lay down, starting and stopping on demand from the blending hopper. This ensures maximum efficiency and blending. The objective of an opening line is to reduce the size of fiber tufts from the bale to the chute feed, which supplies the web forming machine.

### Step 2:

Downstream the bale openers (110,120,130), the fibers may be weighed for proper mix percentage (%). The opened fibers are deposited into a weigh pan controlled by load cells which dump the fibers onto a feed conveyor or conveyor belt (200) until to reach first a fine fiber opener (210) and then another suitable machine (220), such as a Garnett™ machine, a Air-bail Air forming machine™ or a Card™ machine, or the like, in order to from a thin non woven web having a thickness from about 1 mm to about 8 mm.

### Step 3:

Downstream the Garnett™ machine (220), the fiber blend is a thin structured nonwoven web fabric, having a weight from about 10 grams per square meter (or gsm) to about 200 gsm. The structured wed fabric may be then fed to a cumulating machine (300), where it is further layered. For example, the cumulating machine (300) may be a cross-lapping or folding machine that cross-laps the thin structured web nonwoven fabric to make a multi-layered nonwoven matt.

### Step 4:

Downstream the accumulating/cross-lap machine (300), the multi-layered structured nonwoven web is fed to an oven (400), also named “thermo bonding oven”, where it is heated to a temperature above the softening point of the synthetic fibers so that the synthetic fibers become thermally bonded to the cellulosic fibers, forming as such a consolidated nonwoven web. Preferably the temperature inside the oven is superior to about 100° C. More preferably, the temperature is between about 120° C. and about 160° C.

### Step 5:

Downstream the oven (400), the consolidated nonwoven web can be then slit to desire width and cut to desired length using proper machinery (500) known in the art, and roll for distribution using for example a winding machine (510).

Other known process for the making of nonwoven fabric may be used, such as carding, Aerodynamic web forming, Airlay® carding, random card or the like, without falling outside the scope of the present invention.

### The FR Chemical Compounds

The nonwoven web is treated by an aqueous solution comprising a certain amount of FR chemical compound. Any sort of FR chemical compounds can be used without falling outside the scope of the present invention. For example, such as those disclosed in U.S. patent applications 2008/0038973 A1 (SASSER et al.) and 2007/0186353 A1 (FANG), both incorporated herein by reference.

Preferably, the FR chemical compound is a phosphate and/or sulfate salts such as, but not limited to, monoammonium phosphate (or MAP), diammonium phosphate (or DAP), ammonium polyphosphate (or APP), or diammonium sulfate. In the following examples, a solution of 42 wt. % of DAP is prepared and used. This FR solution can be also commercially obtained as Pyrozyl WAR® from Apollo Chemical Division.

The application of the FR chemical compound can be made using FR aqueous solutions, FR foaming solutions or a mix of all of these formulations of the FR chemical compound.

Optionally, a weak base, such as urea can be added to the FR solution. Other kind of weak base can be used if need be. Urea may help to fix the FR chemical compound to the cellulosic fibers and improve the resistance of the link between the compound and the fibbers when they are washed with water.

The application of the FR chemical compound can be made using any kind of soaking, applying, spraying or misting methods or the like.

Preferably, the application of the FR chemical compound can be made using a shower, a spray, a rotor spray, a foaming applicator and/or other application systems, applied at one or multiple locations during the nonwoven process.

More preferably, the present process uses a spray application system for the aqueous solutions that delivers a precise, uniform and consistent amount of FR solutions inside or topical to the nonwoven web.

In the following examples, a spray applicator used is a rotor spray IQ-141™ provided by Ahlbrandt System GMBH (Germany) or Consultex Systems, Inc. (USA). The rotor spray WEKO™ by Weko (Germany) can also be used. These rotor sprays are generally used for surface coating.

Other known devices known for surface application may be used without falling outside the scope of the present invention.

Referring to FIG. 1, the production line may comprise from 1 to 4 spray applicators identified as P1 (Position 1), P2 (Position 2), P3 (Position 3) and P4 (Position 4). The present invention is not limited to the number and position of spray applicator used in the production line.

In position 1 (P1), the spray applicator is located after the Garnett™ machine (220) and before the layering machine (300), when the nonwoven web has a minimum weight from about 10 gsm to about 200 gsm, and a minimum thickness, in order to perform a maximal impregnation of the FR solution throughout the structured unfolded fiber web.

In position 2 (P2), the spray applicator is located before the thermo bonding oven (400) and above the structured nonwoven web.

In position 3 (P2), the spray applicator is located after the thermo bonding oven (400) and above the structured nonwoven web.

In position 4 (P4), the spray applicator is located after the thermo bonding oven (400) and below the structured nonwoven web.

Spraying in P3 and P4 is preferably conjointly made above and below the bonded nonwoven web in order to maximize the impregnation by the FR chemical compound. In that case, the process also preferably comprises a step of drying the web using a dryer (430) in order to evaporate the water from the bonded nonwoven. The drying temperature may be from about 80° C. to about 200° C.

### Process 2:

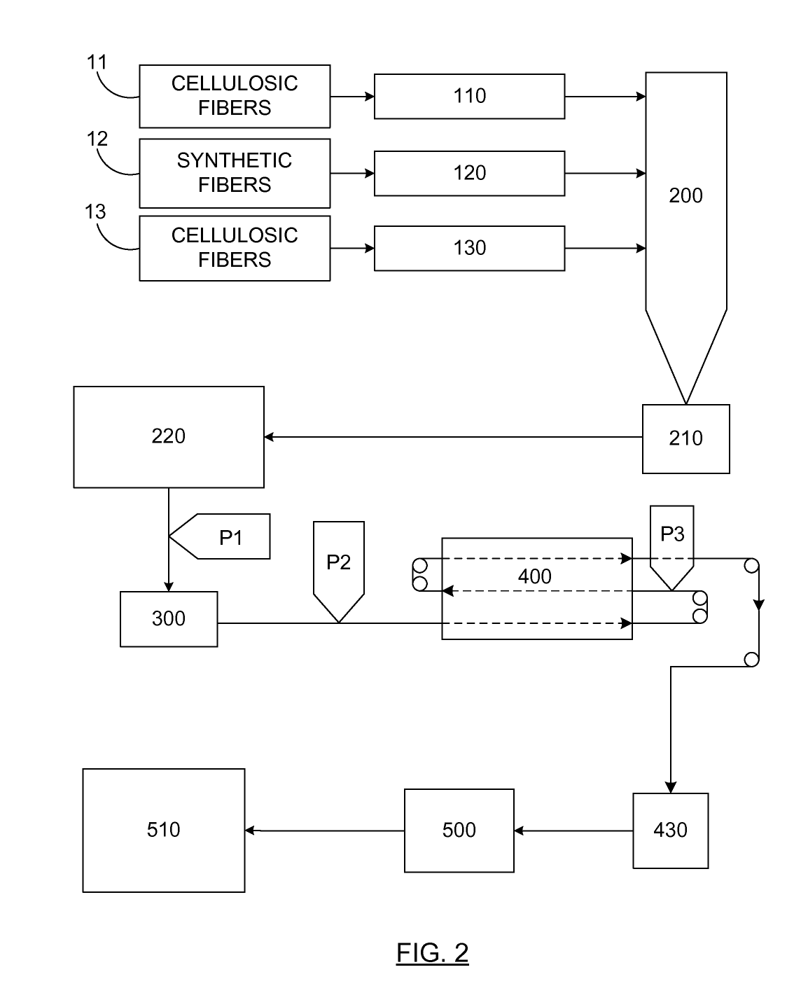

A second process for the making of an FR nonwoven material according to a second preferred embodiment of the invention, is illustrated on FIG. 2.

Process 2 includes the same steps detailed above for Process 1 except that the structured nonwoven web passes three times inside the thermo-bonding oven (400), and that the production line may comprise from 1 to 3 spray applicators identified as P1 (Position 1), P2 (Position 2),and P3 (Position 3).

As for process 1, in position 1 (P1), the spray applicator is located after the Garnett™ machine (220) and before the layering machine (300).

As for process 1, in position 2 (P2), the spray applicator is located before the thermo bonding oven (400) and above the structured nonwoven web.

Position 3 (P3) of the spray applicator is located after the first pass into the oven (400) after the web has changed of direction and before to be reintroduced for the second time inside the oven. This change of direction allows the second face of the nonwoven web, which has not been treated by the spray in position 2, to be also treated but from above the web.

### Process 3:

A third process for the making of an FR nonwoven material according to a third preferred embodiment of the invention, has been used. This third process includes the same steps detailed above for Process 2 and illustrated in FIG. 2, except that the thermo-bonding oven (400) has been replaced by a mechanical needlepunching system used for intermingling the fibers. Process 3 may be used when the selected fibers do not contain thermo-bonding fibers (see example 6 below).

### Process 4:

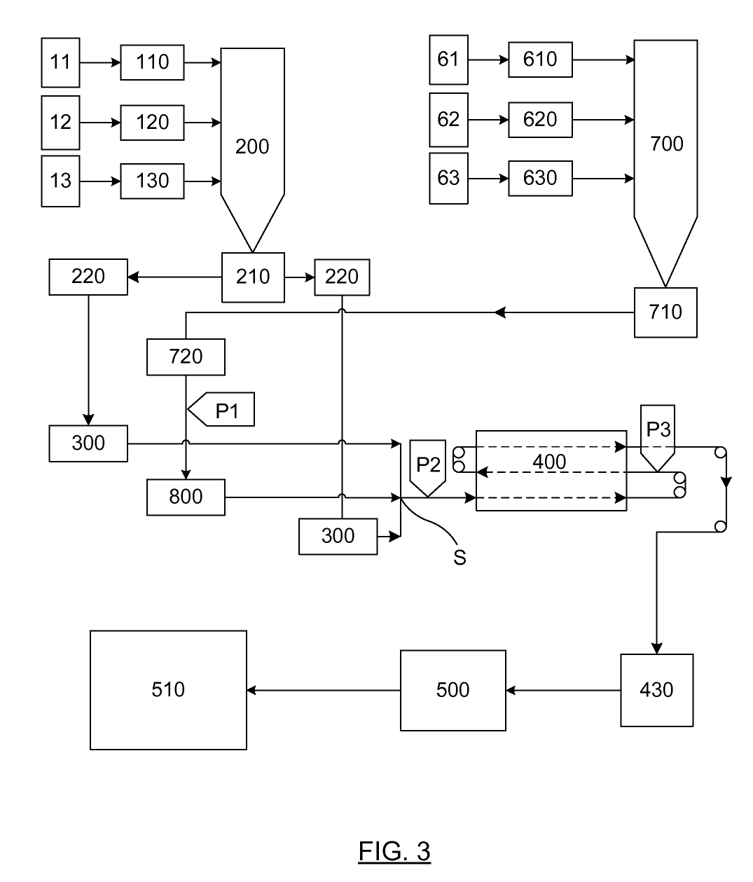

A fourth process for the making of an FR nonwoven material according to a fourth preferred embodiment of the invention, is illustrated on FIG. 3. As illustrated, Process 4 includes two blend lines in parallel and identical to the blend line illustrated in FIG. 2, in order to form a three layer structured nonwoven web.

The three layer web comprises:
two identical top and bottom layers made by the first blend line by mixing fibers (11, 12, 13) using the same machinery detailed for process 1 (110, 120, 130, 200, 210, 220 and 300), and
a central layer made by the second blend line by mixing other fibers (61, 62, 63). The second line comprises bales openers (610, 620, 630), a conveyor (700), a fine fiber opener (710), a Garnett™ or the like (720) and a cumulating machine (800).

Downstream the fine opener (210) f the first line, two lines is subdivided to form the top and bottom layers.

Downstream the cumulating machines (300, 800), and before entering into the oven (400), the three structured non woven webs are superposed in a sandwich configuration (S).

In position 1 (P1), the spray applicator is located after the Garnett™ machine (720) of the second line and before the layering machine (800), in order to treat the central web.

In position 2 (P2), the spray applicator is located before the thermo bonding oven (400) after the three webs have been associated, and above the structured nonwoven web, in order to treat the top layer.

In position 3 (P3), the spray applicator is located after the first pass into the oven (400) when the web has changed of direction to be reintroduced for the second time into the oven. This change of direction allows the bottom layer of the three associated webs to be treated from above

### Test, Apparatus and Procedure to Evaluate the FR Nonwoven Barrier Performance:

Tests and apparatus have been designed to qualify FR nonwoven material prior to send it for quilting and final assembly, for example in a mattress.

### Measure of the Temperatures:

A FR barrier is sent for the CPSC require test: 16 CFR 1633 open flame test. Details of the 16 CFR 1633 test procedure are disclosed on the U.S. Consumer Product Safety Commission (CPSC) website at the following address: http://www.cpsc.gov.

A piece of about 12″ X about 12″ of the FR nonwoven barrier is positioned on a metal frame. A flame at about 50,000 BTU is produced by a propane gas burner with a volume control at about 25 PSI and for about 50 seconds. An infrared thermometer on the other side of the FR nonwoven barrier is positioned for reading the temperature of the fabric escalating over time and transmitting the information to the computer. The IR thermometer generally measures the temperature in the core of the fabric.

The burn test apparatus includes a computer with specific software for controlling the duration of the test and record the temperature during the test. All data are stored per products and can be transposed on a graph. This apparatus allows us to perform burn tests on samples of the FR nonwoven barrier on a vertical and/or horizontal position. Preferably, the test is performed on a vertical position where the test is more severe.

To complete the temperature measurement, the temperature at the surface of the fabric is also measured using a four point temperature label such as those commercialized by OMEGA ENGINEERING INC. (Canada) under the name TLC-label™.

A positive test corresponds to a temperature of less than about 500° F. (260° C.), at any time during the 50 seconds.

It is worth mentioning that the lower is the temperature on the other side of the FR barrier, the better is the FR barrier for protecting against flame and heat.

### Measure of the LOI (Limiting Oxygen Index):

A good initial indication of a material's ability to resist combustion is the measure of its Limiting Oxygen Index (LOI). It is the concentration of oxygen in the test environment needed to sustain combustion of a sample of the material. Since the normal environmental oxygen concentration is approximately 21%, substances which readily burn at an LOT of 21 or less are considered to be flammable while those requiring a higher LOI index are considered to be flame resistant.

### Measure of the Tensile Resistance:

### Tensile Test CGSB (Canadian General Standards Board) 4,2 No. 9.2-M90.

Details are publicly available on the Internet at the following address: http://www.tpsgc-pwgsc.gc.ca.

### Tensile Strength Test-Grab Test ASTM D 5034-95: Standard Test Method for Breaking Strength and Elongation of Textile Fabrics (Grab Test).

This test determines the breaking strength and elongation of most textile fabrics. It is applicable to woven, non-woven, and felted fabrics, while the modified grab test is used primarily for woven fabrics. Details are publicly available on the Internet at the following address:http://www.astm.org.

### EXAMPLES 1 TO 9

Table 1 below resumes the different fibers blending used in example 1 to 9.

TABLE 1
Fibers

| | | | | Synthetic |
|---|---|---|---|---|
| | Cellulosic fibers (wt. %) | | | Fibers (wt. %) |
| | | Inherent | | Bicompo- |
| Examples | Viscose^{a} | Viscose^{b} | Cotton^{c} | nent^{d} |
| 1 | 80 | — | — | 20 |
| 2 | 40 | — | 40 | 20 |
| 3 | 40 | 40 | — | 20 |
| 4 | 50 | 30 | — | 20 |
| 5 | 40 | 40 | — | 20 |
| 6 | 50 | 50 | — | — |

| | |
|---|---|
| Line 1 | Line 2 |

| | | Bicompo- | Inherent | Bicompo- |
|---|---|---|---|---|
| | Viscose^{a} | nent^{d} | Viscose^{b} | nent^{d} |
| 7 | 54^{e} | 20 | 80 | 20 |
| 8 | 80^{e} | 20 | 80 | 20 |
| 9 | 60^{e} | 20 | 40 | 20 |

Notes for Table 1:
^{a}Regular untreated staples viscose fibers of about 5 Deniers by about 75 mm long.
^{b}Inherent viscose fibers of about 5 Deniers by about 50 mm long (FR Corona ™ from Daiwabo)
^{c}Cotton fibers with length varying from 20 mm to 50 mm.
^{d}Bi-component polyester fibers of about 4 Deniers by about 51 mm long.
^{e}Regular untreated staples viscose fibers of about 5 Deniers by about 89 mm long.

Conventional card and cross lap machines are used for the making of a nonwoven fabric. These above fibers are preferably thermo bonded in an high loft nonwoven web in a thermo-bonding oven at about 150° C. for in-between about 2 minutes to about 5 minutes depending on the line speed in relation with the web weight. For the FR aqueous application, a rotor spray IQ-141™ provided by Ahlbrandt System GMBH can be used.

In these example, an FR solution of Pyrozyl® WAR from Apollo Chemical Division is used, which is a solution comprising diammonium phosphate (DAP) at about 42 wt. % solid mix with water.

Table 2 below resumes the different processes 1 to 4 used as detailed above, the positions of the sprays for each process and the amount of FR chemical applied to the web. The first number (wet %) corresponds to the amount of solution spread on the web in % of the total weight of the web, and the second number (% solid) indicates the amount of the dry chemical compound remaining in the web after evaporation of the water, in % of the total weight of the web.

TABLE 2
Processes

| | | | | | | | | | | | Total | | |
|---|---|---|---|---|---|---|---|---|---|---|---|---|---|
| | | | P1 | | P2 | | P3 | | P4 | | web | Total | Total |
| | | Weight | % | % | % | % | % | % | % | % | solution | g/m² | g/m² |
| Ex. | Process | g/m² | Wet | Solid | Wet | Solid | Wet | Solid | Wet | Solid | % solid | wet | solid |
| 1 | 1 | 244 | 8 | 3.2 | — | — | 8 | 3.2 | 8 | 3.2 | 9.6 | 58.6 | 23.4 |
| 2 | 2 | 244 | 6 | 2 | 6 | 2 | 6 | 2 | — | — | 6 | 43.9 | 14.6 |
| 3 | 2 | 244 | 1 | 0.4 | 6 | 2 | 6 | 2 | — | — | 4.4 | 31.7 | 10.7 |
| 4 | 2 | 305 | — | — | 5 | 1.67 | 5 | 1.67 | — | — | 3.34 | 30.5 | 10.2 |
| 5 | 2 | 183 | — | — | 7 | 2.8 | 7 | 2.8 | — | — | 5.6 | 25.6 | 10.2 |
| 6 | 3 | 244 | 1 | 0.4 | 6 | 2 | 6 | 2 | — | — | 4.4 | 31.7 | 10.7 |
| 7 | 4 | 248 | — | — | 6 | 2 | 6 | 2 | — | — | 4 | 29.8 | 9.9 |
| 8 | 4 | 252 | 4 | 1.6 | 6 | 2 | 6 | 2 | | — | 5.6 | 40.3 | 14.1 |
| 9 | 4 | 244 | — | — | 6 | 2 | 6 | 2 | — | — | 4 | 29.3 | 9.8 |

Table 3 below resumes the properties of each FR nonwoven obtained by the process of examples 1 to 9.

TABLE 3
Results

| | | | Chemical | Temperatures | |
|---|---|---|---|---|---|
| | Weight | Thickness | content | IR/Temp. | |
| Examples | (g/m²) | (mm) | (wt. %) | label(F.) | LOI |
| 1 | 244 | 14 | 10 | 440/375 | 32 |
| 2 | 244 | 14 | 6 | 450/385 | 29 |
| 3 | 244 | 14 | 4.5 | 420/375 | 35 |
| 4 | 305 | 16 | 3.4 | 380/290 | 36 |
| 5 | 183 | 15 | 5.6 | 470/400 | 32 |
| 6 | 244 | 10 | 4.5 | 410/360 | 34 |
| 7 | 248 | 16 | 4.0 | 420/375 | 33 |
| 8 | 252 | 15 | 5.6 | 429/385 | 32 |
| 9 | 244 | 17 | 4.0 | 430/380 | 34 |

Table 4 below resumes tensile test made on different pieces of nonwoven material made according to the process of the invention according to two different protocols.

Comparison is made with a piece of nonwoven material commercialized by MILLIKEN & Co. (USA). These data are average values of examples 1 to 9 obtained with five samples for each example.

TABLE 4
Tensile tests

| | | | | |
|---|---|---|---|---|
| | Average | Average | Average | Average |
| | weight | weight | tension | tension |
| | (machine | (machine | (machine | (machine |
| | direction) | direction) | direction) | direction) |
| Material | (g/m²) | (g/m²) | (N) | (N) |

Test CAN/CGSB - 4.2 No. 9.2-M90

| | | | | |
|---|---|---|---|---|
| After fire test | 299.0 | 299.8 | 5.2 | 13.7 |
| Before fire test | 248.0 | 254.3 | 16.1 | 58.4 |
| Milliken (before | 247 | 241.5 | 7.3 | 19.1 |
| burning test) | | | | |

Test ASTM D 5034-95 (Grab Test)

| | | | | |
|---|---|---|---|---|
| Jasztex Before | 244.8 | 246.8 | 14.6 | 42.6 |
| fire test | | | | |
| Milliken (Before | 247.8 | 252.3 | 6.9 | 14.3 |
| burning test ) | | | | |

Each FR nonwoven material obtained by the process of the present invention shows a higher resistance to tension before the burning test and also show better results than competition after the burning test. Indeed, the product of the competition after the flame test was too weak and brittle to complete the test.

The char acts as a thermal barrier that is effective in reducing the amount of heat that is transmitted through it. This reduction is heat prevents material behind the FR fabric from igniting.

In each case, the FR Barrier obtained by the process maintains is white color.

The nonwoven FR barriers as per examples 1 to 9, has reached a core and surface maximum temperatures in between about 380/290° F. (example 4) and about 470/400° F. (example 5). It is to be noted that this maximum temperature of 470° F. corresponds to the lighter material produced (183 gsm). However the LOT of the FR nonwoven material is of about 32 which is more than satisfying.

On a benchmark comparison test, a nonwoven barrier of the competition (Milliken, USA) is in between about 477 to about 500° F. (247 to 260° C.).

The objectives of the FR nonwoven barrier of the invention have been reached in that it minimizes the heat transfer and block the flame by creating a char, to the underlying products in a mattress (foam and other flammable products) and thereby prevents a flames from “breaking through” the char barrier and igniting underlying materials.

Although the present invention has been explained hereinabove by way of preferred embodiments thereof, it should be pointed out that any modifications to these preferred embodiments within the scope of the present invention are not deemed to alter or change the nature and scope of the present invention.

What is claimed is:

1. A process for making a fire resistant nonwoven material, which comprises the steps of:
a. selecting cellulosic fibers and optionally synthetic fibers;
b. feeding a machinery serving to make the nonwoven material with said fibers, and
c. treating said fibers at least one time with at least one fire retardant chemical compound while said machinery is making the non-woven material for obtaining the requested fire resistant nonwoven material.

2. The process of claim 1, wherein:
in step a, use is made of both cellulosic fibers and synthetic fibers, and step b comprises the sub-steps of:
b1. intermingling the fibers selected in step a) to form a structured nonwoven web; and
b2. heating the structured nonwoven web of step b1) for thermally bonding the synthetic fibers to the cellulosic fibers and forming a consolidated nonwoven web.

3. The process of claim 2, wherein in step c, the nonwoven web is treated before, during and/or after sub-step b2) with a given amount of said at least one fire retardant chemical compound.

4. The process of claim 2, wherein in step c, the nonwoven web is treated by spraying an aqueous solution or foam comprising said at least one fire retardant chemical compound.

5. The process of claim 4, wherein said aqueous solution or foam is spread above and/or below the nonwoven web formed in sub-steps b1) and/or b2).

6. The process of claim 4, wherein said aqueous solution or foam further comprises a given amount of urea.

7. The process of claim 1, wherein said at least one fire retardant chemical compound comprises phosphate and/or sulfate salts.

8. The process of claim 1, wherein said at least one fire retardant chemical compound comprises monoammonium phosphate, diammonium phosphate, ammonium polyphosphate, diammonium sulfate or a mixture thereof.

9. The process of claim 1, wherein said cellulosic and synthetic fibers are virgin fibers; a mixture of virgin fibers and fire retardant fibers; or fire retardant fibers.

10. The process of claim 9, wherein said fire retardant fibers are inherent and/or pre-treated fire retardant fibers.

11. The process of claim 1, wherein said cellulosic fibers are made of cotton, rayon, viscose, cellulose acetate, cellulose triacetate, jute, hemp, or mixtures thereof.

12. The process of claim 1, wherein said synthetic fibers are made of polyamides, polyester, polyethylene, polypropylene, polyvinyl, polyacrylic or mixtures thereof.

13. The process of claim 1, wherein said synthetic fibers are mono or bi-component thermo bonding fibers.

14. The process of claim 1, wherein said synthetic fibers are bi-component thermo bonding fibers made of a first polymer forming a core coated by a second polymer forming a sheath, the second polymer having a softening temperature lower than a softening temperature of the first polymer.

15. The process of claim 13, wherein the bi-component fibers comprise a polyester core having a softening temperature of about 110° C. surrounded by a polyester sheath having a softening temperature of 240° C.

16. The process of claim 1, further comprising the step of adding to the fibers a given amount of a thermo bonding powdered resin during the making of the nonwoven fire resistant material.

17. A fire resistant nonwoven material obtained by the process of claim 1, which comprises:
from about 75 wt. % to about 100 wt. % of cellulosic fibers;
from about 0 to about 25 wt. % of synthetic fibers; and
a given amount of at least one fire resistant chemical compound.

18. The fire resistant nonwoven material of claim 17, comprising from about 3 to 20 g/m² of said at least one fire resistant chemical compound.

19. The fire resistant nonwoven material of claim 17, wherein said at least one fire retardant chemical compound comprises phosphate and/or sulfate salts.

20. The fire resistant nonwoven material of any of claims 17, wherein said at least one fire retardant chemical compound comprises monoammonium phosphate, diammonium phosphate, ammonium polyphosphate, diammonium sulfate or a mixture thereof.

21. The fire resistant nonwoven material of claim 17, wherein said cellulosic fibers are made of cotton, rayon, viscose, cellulose acetate, cellulose triacetate, jute, hemp, or mixtures thereof.

22. The fire resistant nonwoven material of claim 17, wherein the synthetic fibers are made of polyamides, polyester, polyethylene, polypropylene, polyvinyl, polyacrylic or mixtures thereof.

23. The fire resistant nonwoven material of any one of claims 17, wherein the synthetic fibers are mono or bi-component thermo bonding fibers.

24. The fire resistant nonwoven material of any one of claims 17, wherein the synthetic fibers are made of thermo bonding bi-component fibers made of a first polymer forming a core coated by a second polymer forming a sheath, the second polymer having a softening temperature lower than a softening temperature of the first polymer.

25. The fire resistant nonwoven material of claim 17, wherein from about 80% to about 100% of the fibers are treated with said at least one fire resistant chemical compound.
